(19) United States
(12) Patent Application Publication
(10) Pub. No.: US 2012/0327380 A1
(43) Pub. Date: Dec. 27, 2012

(54) LIGHT SOURCE APPARATUS

(75) Inventor: Hirohisa Iwabayashi, Hyogo (JP)

(73) Assignee: USHIO DENKI KABUSHIKI KAISHA, Tokyo (JP)

(21) Appl. No.: 13/582,629

(22) PCT Filed: Mar. 3, 2011
(86) PCT No.: PCT/JP2011/054865

§ 371 Date: Sep. 4, 2012

(30) Foreign Application Priority Data
Mar. 4, 2010 (JP) 2010-047569

(51) Int. Cl. G03B 21/28; F21V 7/22; F21V 7/00

(52) U.S. Cl. 353/99; 362/297

(57) ABSTRACT

A light source apparatus includes a short-arc-type mercury lamp, a main reflection mirror, a sub-reflection mirror, and an optical element. The sub-reflection mirror surrounds an opening of the ellipsoid main reflection mirror. The sub-reflection mirror reflects a portion of the light emitted from the lamp toward the main reflection mirror. The light reflected by the sub-reflection mirror is reflected toward the main reflection mirror. The optical element is arranged between a second focal point of the main reflection mirror and the sub-reflection mirror. The light reflected by the main reflection mirror and passes through an opening of the sub-reflection mirror is incident upon an incidence-side face of the optical element. The optical element transmits visible light and to reflect ultraviolet light, while the main reflection mirror transmits infrared light and reflects ultraviolet light and visible light and the sub-reflection mirror reflects ultraviolet light and visible light.

### TECHNICAL FIELD

The present invention relates to a light source apparatus. Specifically it relates to a light source apparatus used for a projector apparatus.

### BACKGROUND ART

In general, there are projector apparatuses using a liquid crystal (LCD) panel and projector apparatuses using a DLP (Registered Trademark). As the LCD panel projector apparatuses, there are one sheet type LCD panel projector apparatuses and three sheet type. In either type, light emitted from a light source is divided into three colors (RGB). The divided light beams correspond to image information and are adjusted in and passed through the LCD panel, after which the three light beams transmitted through the panel are synthesized and projected onto a screen. On the other hand, in the DLP type projector, a spatial modulation element (which is also called an optical modulation device and which comprises, for example, a DMD element) is irradiated with radiation light from a light source in a time dividing manner through a rotary filter that has been divided into RGB areas, and specific light is reflected with this DMD element so that a screen is irradiated therewith. The DMD element has the structure in which millions of small mirrors, each of which corresponds to a pixel, are laid, and projection of light is controlled by controlling the direction of each small mirror. Since an optical system of the DLP type is simple compared with the LCD type and it is not necessary to use three LCD panels, there is an advantage that the apparatus thereof is small-sized and simplified as a whole.

On the other hand, a short arc type mercury lamp, which has high vapor pressure, is used as a light source of such a projector apparatus. This is because high output light in a visible wavelength range can be obtained by such a lamp whose mercury vapor pressure is high. Moreover, this short arc type mercury lamp is installed in a concave reflection mirror in the shape of an ellipsoid of revolution, in order to make bright an image which is projected on a screen. This is because light, which is emitted in all directions from the short arc type mercury lamp, is condensed by using a concave reflection mirror, and the limited area of the screen can be efficiently irradiated with the light.

In recent years, in order that, for example, a projector apparatus used for a presentation may be easily carried, the reduction in size and weight of the apparatus is strongly demanded. If the miniaturization of such a projector apparatus is required, naturally, a miniaturization of a light source apparatus comprising a short arc type mercury lamp, a concave reflection mirror, etc., which are installed in the projector apparatus, is required. On the other hand, of course, even if the size and shape thereof is restricted, the usage efficiency of light emitted from the short arc type mercury lamp cannot be reduced.

FIG. 9 shows a schematic structure of a light source apparatus proposed in prior art. This light source apparatus is disclosed in Japanese Patent Application Publication No. H11-64795, wherein a main reflection mirror 20 and a sub-reflection mirror 30, which is provided separately from the main reflection mirror 20, are provided. In the prior art apparatus, light that directly enters the main reflection mirror 20 from the short arc type mercury lamp 10 is combined with light 54 that is emitted towards a front side thereof and reflected by the sub-reflection mirror 30 so as to be used as output light 51. Furthermore, the prior art discloses a function of correcting an optical path of light emitted from the reflection mirror by a lens 42.

However, in such a light source apparatus of the related art, because a loss occurs when the light which enters the sub-reflection mirror 30 is reflected, and a loss is also produced when the reflected light passes through between the electrodes of the light emission section 11, it is more difficult to obtain sufficient brightness as such a miniaturization is achieved, compared with a light source apparatus, which is made up of only a main concave reflection mirror of which the miniaturization is not demanded.

### CITATION LIST

### Patent Literature

Patent document 1: Japanese Patent Application Publication No. H11-64795

### DISCLOSURE OF INVENTION

### Technical Problem

It is an object of the present invention to offer a light source apparatus, which meets a demand for a miniaturization thereof while radiation light of a short arc type mercury lamp can be efficiently used.

### Solution to Problem

In order to solve the above-mentioned problem, a light source apparatus according to the present invention, comprises: a short arc type mercury lamp, which is made up of a light emission section including a pair of electrodes, and sealing portions provided at both ends of the light emission section, wherein an arc direction and an optical axis of the short arc type mercury lamp coincide with each other; a main reflection mirror, which has a face in shape of an ellipsoid of revolution and which is arranged so as to surround the short arc type mercury lamp in a state where a primary focal point thereof is formed approximately between the electrodes; and a sub-reflection mirror, which is arranged so as to surround an opening of the main reflection mirror, and which reflects, toward the main reflection mirror again, light directly emitted from the short arc type mercury lamp to a side of the opening of the main reflection mirror, an opening being formed in the sub-reflection mirror, through which light reflected by the main reflection mirror passes, wherein, the main reflection mirror reflects ultraviolet light and visible light in light emitted from the short arc type mercury lamp and transmits infrared light therein, wherein the sub-reflection mirror reflects ultraviolet light and visible light contained in the light emitted from the short arc type mercury lamp, and wherein a wavelength selective optical element, which transmits visible light and reflects ultraviolet light contained in the light reflected by the main reflection mirror, is arranged between a second focal point position of the main reflection mirror and the sub-reflection mirror.

The light source apparatus is characterized by the sub-reflection mirror transmitting infrared light in the light, which is emitted from the short arc type mercury lamp.

The light source apparatus is characterized by the sub-reflection mirror made from aluminium material.

The light source apparatus is characterized by the wavelength selective optical element having an incidence plane, which is formed so that the light emitted from the main reflection mirror is vertically incident thereon, wherein a film is formed on the incidence plane and transmits visible light and reflects ultraviolet light.

The light source apparatus is characterized by the incidence plane of the wavelength selective optical element being flat, and the wavelength selective optical element having a film, which transmits visible light and reflects ultraviolet light, on the incidence plane.

The light source apparatus is characterized by the sub-reflection mirror formed of a spherical reflection mirror.

The light source apparatus is characterized by the diameter of the opening of the main reflection mirror and the diameter of the opening of the sub-reflection mirror on an incidence side coinciding with each other. The light source apparatus is characterized by the diameter of the opening of the sub-reflection mirror on the incidence side being larger than the diameter of the opening of the main reflection mirror.

The light source apparatus is characterized by the opening of the sub-reflection mirror on the incidence side being continuously formed to the opening of the main reflection mirror, and a relation of 30 degrees≦X≦90 degrees being satisfied, wherein, on a cross section of the main reflection mirror, taken along a plane containing the optical axis thereof, an angle formed by the optical axis of the main reflection mirror and a virtual line drawn towards a boundary part of the sub-reflection mirror and the main reflection mirror from the center between the electrodes, is represented as X.

The light source apparatus is characterized by a projection being formed at the tip of the electrode of the short arc type mercury lamp.

A projector according to the present invention has the above-mentioned light source apparatus.

### Advantageous Effects of Invention

The present invention has advantageous effects set forth below. (1) Since ultraviolet light in light emitted from the short arc type mercury lamp return to the light emission section of the short arc type mercury lamp, it is possible to raise light emission of the short arc type mercury lamp. This is because the light emission section thereof is maintained at high temperature as a whole, when the ultraviolet light is absorbed by mercury steam within the lamp. (2) Although there is a problem that the electrodes become locally high in temperature and are worn out when visible light in the light emitted from the short arc type mercury lamp, directly returns to the lamp, in the present invention, it has a function of heating mercury steam in an arc as in the ultraviolet light, so that there is an effect in which light emission of the short arc type mercury lamp is raised. Furthermore, since part of visible light, which returns to the short arc type mercury lamp, heats the mercury steam which is lower in temperature than that of the arc portion, and which exists on the container wall of the light emission section of the short arc type mercury lamp and near the container wall of the light emission section, there is an effect in which light emission of the short arc type mercury lamp is raised.

### BRIEF DESCRIPTION OF DRAWINGS

FIG. 1 It is an explanatory cross sectional view showing the overall structure of a light source apparatus according to an embodiment of the present invention.

FIG. 2 It is an explanatory cross sectional view showing a state where light travels in the light source apparatus of FIG. 1.

FIG. 3 It is an explanatory cross sectional view for explaining the relation between the boundary part between the main reflection mirror and a sub-reflection mirror, and an optical axis, in the light source apparatus of FIG. 1.

FIG. 4 It is an explanatory diagram showing the conceptual structure of a light emission section of a short arc type mercury lamp of a light source apparatus according to the present invention.

FIG. 5(a)-(c) are explanatory cross sectional views, respectively showing an example of a wavelength selective optical element according to an embodiment.

FIG. 6 It is an explanatory cross sectional view showing another embodiment of a light source apparatus according to the present invention.

FIG. 7 It is an enlarged explanatory diagram showing the structure of the short arc type mercury lamp in the example of FIG. 1.

FIG. 8 It is an enlarged explanatory diagram showing the electrodes of the short arc type mercury lamp of FIG. 7.

FIG. 9 It is an explanatory cross sectional view showing a light source apparatus of prior art.

### DESCRIPTION OF EMBODIMENTS

A light source apparatus according to the present invention comprises: a main reflection mirror; a sub-reflection mirror arranged on a side of an opening of the main reflection mirror; and a wavelength selective optical element, which is arranged on the optical axis on a side of the sub-reflection mirror, wherein the light source apparatus is configured so that ultraviolet light contained in light emitted from a short arc mercury lamp, is confined in an area surrounded by the wavelength selective optical element and the reflection mirrors, so that the ultraviolet light may not be emitted to the outside of the wavelength selective optical element. That is, this light source apparatus is configured so that the main reflection mirror reflects ultraviolet light and visible light, and transmits infrared light contained in light that is emitted from the short arc type mercury lamp, and so that the wavelength selective optical element, which transmits visible light and reflects ultraviolet light contained in the light reflected by the main reflection mirror, is arranged between the second focal point of the main reflection mirror and the sub-reflection mirror. Concrete configuration thereof is explained referring to figures.

### EXAMPLES

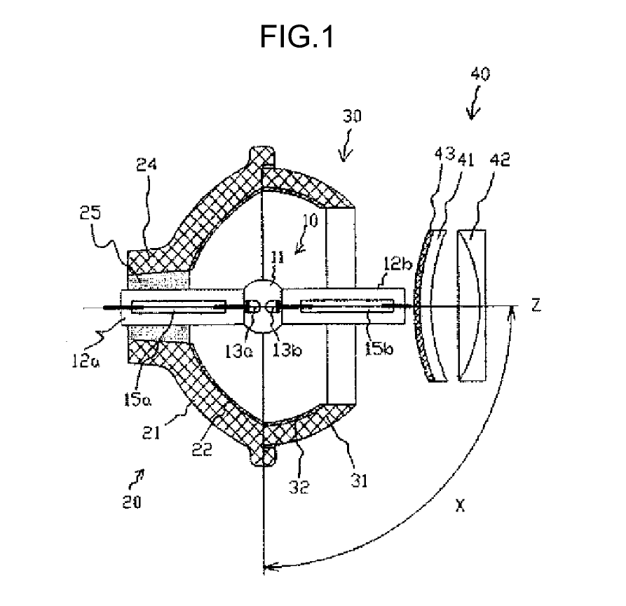

FIG. 1 shows the overall structure of an example of a light source apparatus according to the present invention. The light source apparatus is made up of a short arc type mercury lamp 10, a main reflection mirror 20, and a sub-reflection mirror 30. The main reflection mirror 20 is arranged so as to surround the short arc type mercury lamp 10, and an arc direction of the short arc type mercury lamp 10, i.e., a direction in which the tips of electrodes are connected to each other, and an optical axis Z of the main reflection mirror 20 coincide with each other. Moreover, the main reflection mirror 20 has the structure in the shape of an ellipsoid of revolution, and a primary focal point thereof is located at the center between the electrodes, and the sub-reflection mirror 30 is formed in a spherical structure so as to correspond to the spherical shape of a light emission section of the lamp.

The short arc type mercury lamp 10 has the light emission section 11 whose shape is approximately spherical, and sealing portions 12a and 12b, which are respectively formed at both ends of the light emission section 11, wherein one of the sealing portions 12a is attached to a neck portion (top part) 24 of the main reflection mirror 20. A heat resistant adhesive agent 25 etc. is used in order to fix the short arc type mercury lamp 10 to the main reflection mirror 20, and both of them may be directly attached to each other, as shown in the figure. When a cap (reflector base) (not shown in the figure), which is a separate component, is used, the short arc type mercury lamp 10 may be attached to the cap, and the cap may be fixed to the main reflection mirror 20 and a hole through which a cooling air passes can be also provided in the cap.

A reflection portion 22 of the main reflection mirror 20 has a face in the shape of an ellipsoid of revolution, and has a concave shape as a whole. While borosilicate glass, which is heat resistant glass, is used as base material 21 of the main reflection mirror 20, an interference film, which reflects visible light (VIS) and ultraviolet light (UV), and transmits infrared light (IR), is formed on an inner face thereof. Specifically, provided in the interference film, are a film, which is formed by laminating titania (TiO₂) and silica (SiO₂) by turns on the base material as a first layer, and a film, which is formed by laminating hafnia (HfO₂) and magnesium fluoride (MgF) by turns thereon as a second layer. Thereby, ultraviolet light with wavelength of 300 nm-400 nm can be reflected on the first layer, and visible light with wavelength of 400 nm-700 nm can be reflected on the second layer.

The sub-reflection mirror 30 is attached to the main reflection mirror 20 by a dedicated metallic member such as a heat resistant silicone adhesive and stainless steel material in a state where the opening thereof on the incidence side is connected to the opening of the main reflection mirror 20. In the wake of the light emission section 11 of the short arc type mercury lamp, an inner face of the sub-reflection mirror 30 is formed so as to have a spherical face, so that light that enters the reflective face may be reflected back toward the lamp along the same path on which the light had traveled to the sub-reflection mirror 30. Since the sub-reflection mirror 30 is provided at a position where a separation distance from the light emission section 11 thereto is large so that an influence of high temperature of the short arc type mercury lamp is small, resin, metal, etc. can be used as the base material 31 in addition to glass. The interference film 32, which reflects visible light (VIS) and ultraviolet light (UV) and transmits infrared light (IR), is formed on the inner face of the sub-reflection mirror 30. Specifically, the interference film is formed of a film, which is formed by laminating tantalum (TiO₂) and silica (SiO₂) by turns on the base material as a first layer, and a film, which is formed by laminating hafnia (HfO₂) and magnesium fluoride (MgF) by turns thereon as a second layer. Thereby, ultraviolet light with wavelength of 300 nm-400 nm can be reflected on the first layer, and visible light with wavelength of 400 nm-700 nm can be reflected on the second layer. Of course, the interference film is not limited to the above and it is possible to choose other combinations.

In the above, the diameter of the opening of the main reflection mirror 20 and the diameter of the opening of the sub-reflection mirror 30 approximately coincide with each other desirably. This is because when the diameter of the opening of the main reflection mirror 20 and that of the sub-reflection mirror 30 approximately coincide with each other, it is possible to minimize a maximum outer diameter of the light source apparatus.

A wavelength selective optical element 40 is arranged on a front side of the main reflection mirror 20. The wavelength selective optical element 40 in this example is made up of two lenses 41 and 42. An incidence face of the lens 41 has at least a convex face (a face having a shape where the central part thereof is projected in the same direction (on the left hand side in the figure) as that of the main reflection mirror 20), and has a curved surface so that light beams emitted from the main reflection mirror 20 may enter the incidence face thereof at a right angle. Specifically, as shown in the figure, it is a single lens or cemented lens, whose incidence face is convex and whose light emitting face opposite thereto is concave, and the so-called meniscus lens is desirably used. The traveling direction of light is controlled and adjusted by the lens 42, which forms the wavelength selective optical element 40, on the light emitting side.

The lenses 41 and 42, which form the wavelength selective optical element 40, are attached to a lens holding member (not shown), and this lens holding member is attached to an optical unit (not shown). The lenses 41 and 42 have such a size (outer diameter) that all light from the main reflection mirror 20 may be received, and are arranged at a position where all the light from the main reflection mirror 20 is received. For example, borosilicate glass (for example, TEMPAX; Trademark), which is hard glass, is used as base material of the lens 41, and the lens 41 has an interference film 43, which transmits visible light (VIS) and reflects ultraviolet light (UV), on a surface (incidence plane) of the main reflection mirror 20 side thereof. Specifically, the interference film 43 is made up of a film formed by laminating by turns hafnia (HfO₂) and magnesium fluoride (MgF) on the base material. Thereby, ultraviolet light having wavelength of 300 nm-400 nm can be reflected, and visible light having wavelength of 400 nm-700 nm can be passed through. The antireflection coating (AR coating), which is not shown, is applied to a surface (emitting face), which is on a side opposite to that of the main reflector 20 of the lenses 41 and 42. This is to prevent visible light which has passed through the lenses 41 and 42 from being reflected again. And a projector is configured by arranging a liquid crystal panel or a rotation color filter for DLP on a front side of the wavelength selective optical element 40 with respect to a light traveling direction.

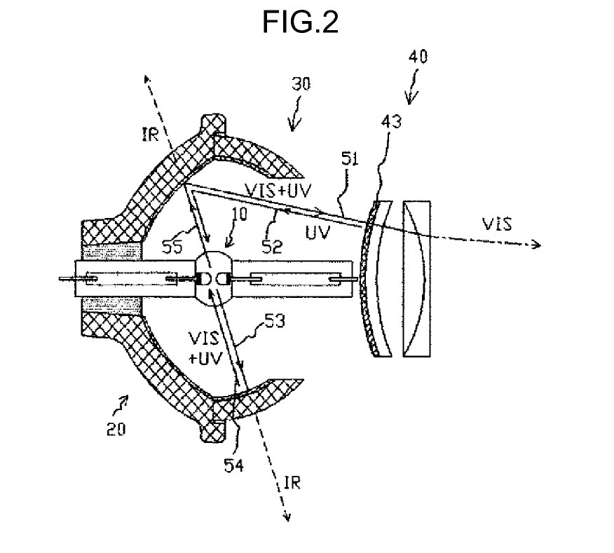

FIG. 2 is a diagram for explaining a state of traveling of light emitted from the short arc type mercury lamp. Visible light (VIS), infrared light (IR), and ultraviolet light (UV) are contained in the light emitted from the short arc type mercury lamp 10. The wavelength range of visible light (VIS) is approximately 400 nm-700 nm, the wavelength range of infrared light (IR) is approximately 700 nm or more, and the wavelength range of ultraviolet light (UV) is approximately 400 nm or less. In the figure, solid lines show light, which is incident on the reflection mirrors and lenses, a dot-dash line shows visible light (VIS), which passes through the lenses and is emitted therefrom, and dotted lines show infrared light (IR). The sub-reflection mirror 30 reflects visible light (VIS) and ultraviolet light (UV) contained in the light 53, which is emitted from the lamp and reaches the sub-reflection mirror 30, and transmits infrared light (IR) contained therein. Next, the main reflection mirror 20 reflects visible light (VIS) and ultraviolet light (UV) in the light 55, which reaches the main reflection mirror 20, and transmits infrared light (IR) therein. The light 55 includes not only light which comes directly from the short arc type mercury lamp 10, but also light reflected by the sub-reflection mirror 30. Furthermore, the wavelength selective optical element 40 transmits visible light (VIS) in the light 51, which reaches the wavelength selective optical element 40, and reflects ultraviolet light (UV) therein. The reflected ultraviolet light (UV) again returns to the short arc type mercury lamp 10 through the main reflection mirror 20. In addition, infrared light (IR) in the light 51, which reaches the wavelength selective optical element, 40 is reflected by the interference film 43.

According to the above structure of the light source apparatus of the present application invention, it is possible to emit only visible light (VIS) to the outside of the light source apparatus. The ultraviolet light (UV) again returns to the light emission section 11 of the short arc type mercury lamp, and is absorbed by mercury steam in the lamp, so that the temperature of the light emission section is raised, and activation thereof is carried out.

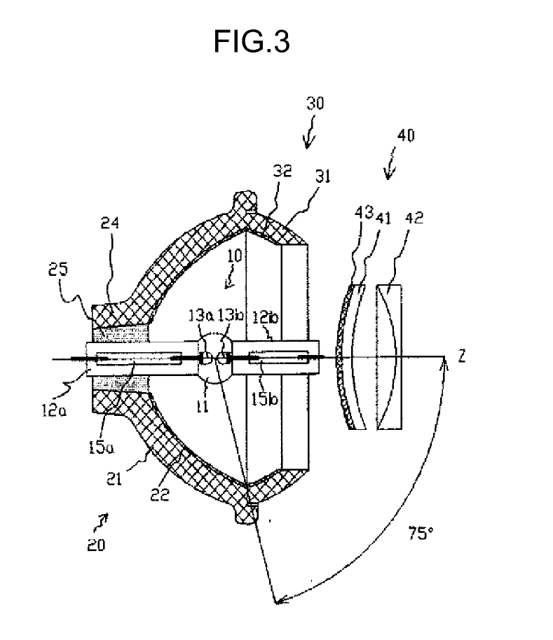

FIG. 3 is an explanatory diagram for explaining that an angle X formed by an optical axis Z of the light source apparatus and a virtual line drawn towards a boundary part of the sub-reflection mirror and the main reflection mirror from the center position between the electrodes of the lamp, satisfies a relation of 30 degrees≦X≦90 degrees. FIG. 3 show a state of X=75 degrees. Since the shapes of both electrodes are almost the same and are comparatively small in the case where the short arc type mercury lamp 10 is of an alternating current lighting type, when the angle X is set to 90 degrees (refer to FIG. 1), an apparent distance (an apparent arc size) between the electrodes at a condensing point can be reduced to approximately a half, so that it is possible to make the light source with a smaller luminescent spot.

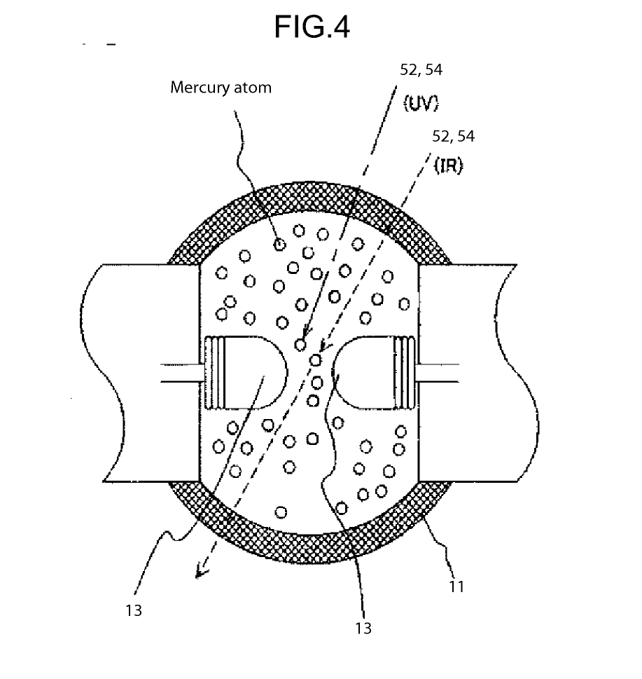

FIG. 4 shows a state where the light emission section 11 of the short arc type mercury lamp is enlarged. The inside of the light emission section 11 is filled with mercury steam. Here, when the mercury steam absorbs ultraviolet light (UV) contained in the return lights 52 and 54 which return to the light emission section 11, the temperature of the light emission section 11 raises. On the other hand, infrared light (IR), which may be contained in the returning light beams 52 and 54, is absorbed by the mercury steam which exists near a container inner wall of the light emission section of the short arc type mercury lamp, and which is lower in temperature than that of an arc portion, so that the temperature of the mercury steam rises and also the temperature of the container inner wall rises. Thereby, light emission of the short arc type mercury lamp is increased. The ultraviolet light and infrared light, which have not been absorbed by the light emission section 11 or the mercury steam, pass through a space between electrodes, and then pass through the short arc type mercury lamp. For this reason, the electrodes are not locally heated to high temperature so that it is possible to avoid damage and wear of the electrodes. Ultraviolet light contained in the return light beams 52 and 54, which have passed through the space of the electrodes, are again reflected by the main reflection mirror 20 and the sub-reflection mirror 30, and returns to the light emission section of the short arc type mercury lamp, so that it is possible to increase light emission of the short arc type mercury lamp. On the other hand, after infrared light passes through the space between the electrodes, it passes through the main reflection mirror 20 without being reflected thereby, and is emitted to the outside of the reflection mirror. Although, similarly to the ultraviolet light, it also seems useful that it is repeatedly reflected between the main reflection mirror 20 and the sub-reflection mirror 30, and returns to the light emission section 11, since the infrared light, which has passed through the space between the electrodes, travels in a direction gradually different from an original optical path and then will directly heat the electrodes, it is preferable that the infrared light, which has passed through the space between electrodes once, passes through the main reflection mirror and is emitted to the outside of the reflection mirrors.

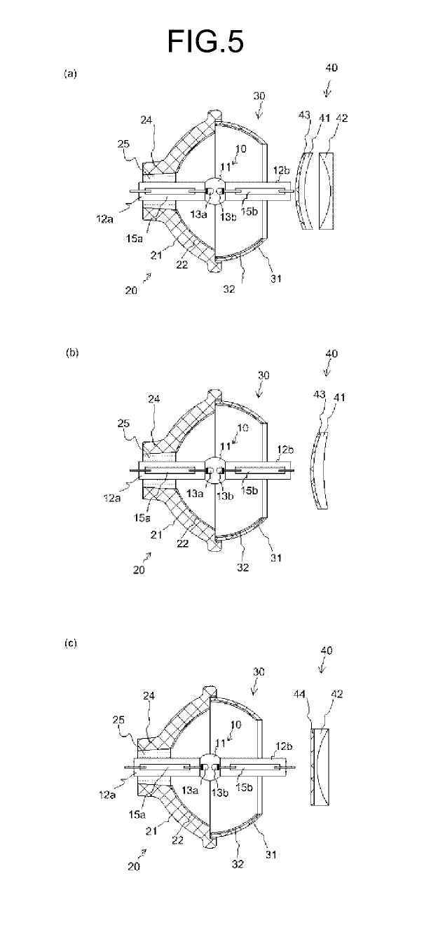

In FIG. 5, (a)-(c) respectively show embodiments of the wavelength selective optical element 40. In each case, a face on a left hand side in the figure is an incidence plane of light, and a face on a right hand side is a light emitting face. In an example of (a), the wavelength selective optical element 40 comprises a lens 41 having an interference film 43 on its incidence plane, which reflects ultraviolet light and transmits visible light, and a lens 42 which controls an optical path. In the structure of an example of (b), the wavelength selective optical element 40 is configured so that an interference film 43 is formed on an incidence plane of the lens 41 which has a function of controlling an optical path. In the structure of an example of (c), the wavelength selective optical element 40 is composed of a lens 42 having a flat incidence face on which an interference film 44 having characteristics similar to the interference film 43 is formed, and a concave light emitting face which is on an opposite side thereto.

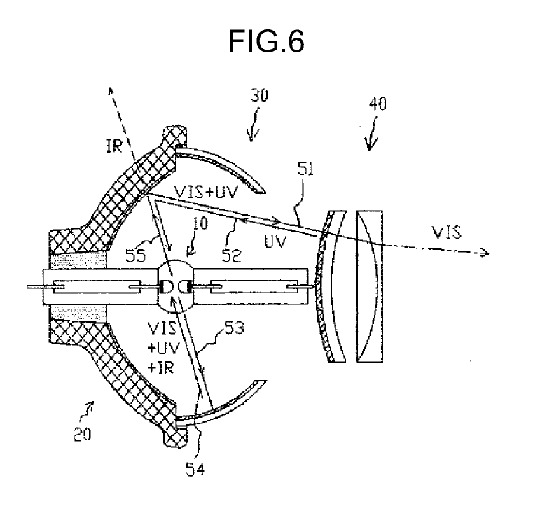

FIG. 6 is an explanatory cross sectional view showing another embodiment of the present invention. Although, in the embodiment shown in FIG. 1, borosilicate glass is used as the base material of the sub-reflection mirror 30, aluminium is used as base material of a sub-reflection mirror 30 in the embodiment of FIG. 6. Since it is the same as that shown in FIG. 1 except that the base material of the sub-reflection mirror 30 is changed into the aluminium, explanation of identical components is omitted. The sub-reflection mirror 30 in this example is manufactured by aluminium spinning, press processing, or cutting etc., and has a revolution reflection face which is the same as that of the example of FIG. 1. Although it is necessary to provide the interference film, which is a reflective component when borosilicate glass is used as the base material, in this embodiment in which it is manufactured with aluminum, the light of all wavelengths, which is emitted from the short arc type mercury lamp, can be reflected, even if the base material is used as it is. In the figure, such a state is shown as reflected light 53. Although it can be also used without processing any reflective face, it can be also used by performing alumite processing for protection of the reflective face. In this case, the light of all wavelengths, which is emitted from the short arc type mercury lamp, can be also reflected thereby. Furthermore, it is possible to form a reflective film made from an interference film without any difficulty, as well as the case where borosilicate glass is used as the base material. Moreover, while the thickness of the base material made of borosilicate glass becomes about 4 mm, when the sub-reflection mirror 30 is made of aluminium the aluminium can be as thin as about 1 mm. Aluminium is also light, and it can be satisfactorily used for strength. A thinner sub-reflection mirror 30 is advantageous in that if the sub-reflection mirror 30 becomes thinner while the outer diameter of the sub-reflection mirror 30 is held constant, the size of the opening in an opening side of the sub-reflection mirror 30 is increased, so that the light flux that can be caught, can be increased.

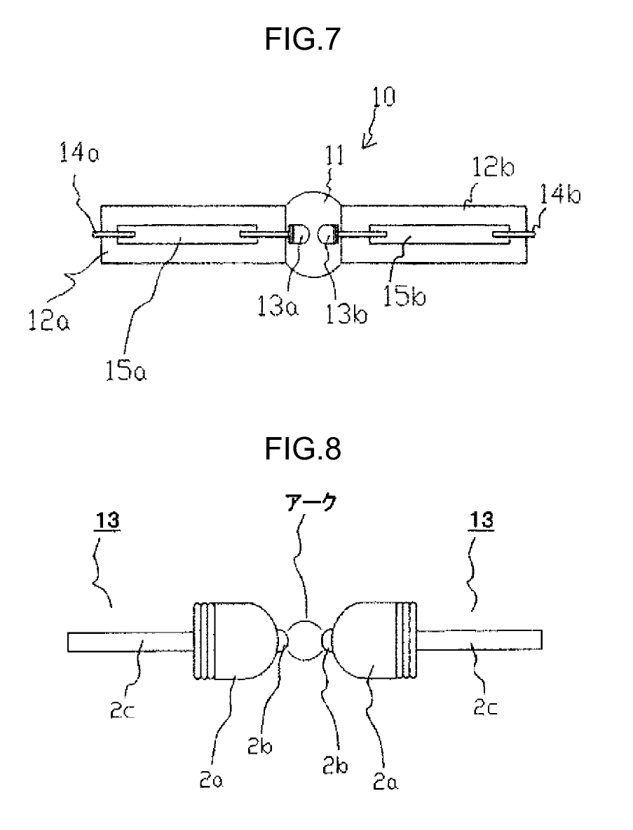

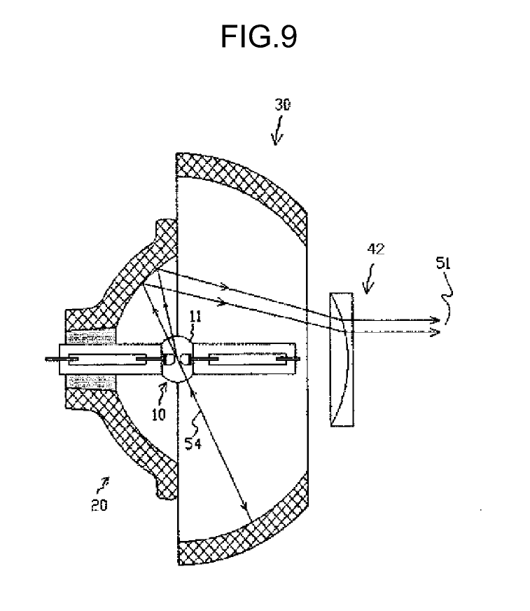

FIG. 7 shows the overall structure of the short arc type mercury lamp 10. The short arc type mercury lamp 10 is a discharge lamp, in which mercury is enclosed, and has the approximately spherical light emission section 11 formed by an electric discharge container which is made of silica glass. A light emission space is formed in this light emission section 11, wherein the electrodes 13a and 13b, which are the same as each other, are arranged so as to face each other at an interval of 0.5 mm-2 mm. The sealing portions 12a and 12b are formed at both ends of the light emission section 11, wherein metallic foils 15a and 15b for electric conduction, which are made of molybdenum, are airtightly buried in the respective sealing portions 12a and 12b by, for example, shrink sealing. An axis portion of each of the electrodes 13a and 13b is joined to one end of each of the metallic foil 15a and 15b, and each of external leads 14a and 14b is joined to the other end of each of the metallic foil 15a and 15b, so that electric power is supplied from an external power supply apparatus. Mercury, rare gas, and halogen gas are enclosed in the light emission section 11. The mercury is used for obtaining ultraviolet light of required wavelength, for example, radiation light of a wavelength of 300 nm-360 nm, wherein 0.15 mg/mm³ or more thereof, specifically 0.15-0.25 mg/mm³ thereof is enclosed. Although the enclosed amount thereof is also different, depending on temperature conditions, the vapor pressure becomes as high as 8 MPa or more at time of lighting.

As the rare gas, argon gas is enclosed at pressure of, for example, approximately 13 kPa. A function thereof is to improve the initialization of light emission. Iodine, bromine, chlorine, etc. are enclosed as a halogen in the form of compounds with mercury or another metal. The enclosed amount of halogen is selected from a range of 5×10⁻⁵-7×10⁻³ μmol/mm³. Although a function of the halogen is to extend a life span of the lamp by using the so-called halogen cycle, there is also a function of preventing devitrification of the electric discharge container, in the case where the discharge lamp is very small and the lighting vapor pressure thereof is very high as in the high pressure discharge lamp of the present invention. If the numerical example of the short arc type mercury lamp is shown, for example, the maximum outer diameter of the light emission section 11 is 9.5 mm, the distance between the electrodes is 1.5 mm, and the internal volume of the light emission section is 75 mm³, rated voltage applied thereto is 70 V, and rated power applied thereto is 200 W, and it is AC-lighted at 350 Hz.

Moreover, this kind of short arc type mercury lamp is built in a projector apparatus to be miniaturized, wherein while a severe miniaturization is required in an overall dimension, high intensity of light emission is also required. For this reason, the thermal influence on the light emission section becomes very severe. A bulb wall load value of the short arc type mercury lamp becomes 0.8-2.0 W/mm², specifically, 1.5 W/mm². By having such high mercury vapor pressure and bulb wall load value, when it is installed in an apparatus for presentation such as a projector apparatus or an overhead projector, it is possible to provide light with good color rendering properties. In addition, the lighting of the short arc type mercury lamp is not limited to alternating current lighting, but may be direct current lighting.

FIG. 8 is a schematic diagram showing tips and projections of the electrodes of the short arc type mercury lamp. The projections 2b is formed at the tip of each electrode 13 (an end portion facing the other electrode) with lighting of the short arc type mercury lamp. The principle of the phenomenon in which the projections 2b are formed is not necessarily clear, but it is thought as set forth below. That is, tungsten (the constituent material of the electrodes), which is evaporated from hot sections near the electrode tips during lamp lighting, is combined with halogen and residual oxygen, which exists in an arc tube, so as to become tungsten compounds such as WBr, WBr₂, WO, WO₂, WO Br, and WO₂Br₂, for example, when the halogen is Br. These compounds are broken down so as to become tungsten atoms or cations at the hot sections in a gaseous phase near the electrode tips . It is thought that when there has been temperature diffusion, that is, diffusion of the tungsten atoms which go to an area adjacent to the electrode tips, which are low temperature parts, from the inside of the arc, which is hot temperature part in the gaseous phase, and when the tungsten atoms are ionized in the arc so as to become cations and there has been a drift in which they are drawn toward the cathode by an electric field when an cathode operation is carried out, the tungsten vapor density in the gaseous phase in the areas adjacent to the electrode tips becomes high, and it deposits at the tips of electrodes, thereby forming the projections.

As in FIG. 8, each of the electrodes 13 is made up of a hemisphere portion 2a and an axis portion 2c, and the projection 2b is formed at the tip of the hemisphere part 2a. Even if these projections 2b do not exist at time of start of the lighting of the short arc type mercury lamp, so to speak, they are spontaneously formed by subsequent lighting. Here, the projections 2b are not necessarily produced in every short arc type mercury lamp. In a short arc type mercury lamp, in which an electrode distance is 1 mm-2 mm, 0.08 mg/mm³ or more of mercury, rare gas, and halogen in a range of 5×10⁻⁵-7×10⁻³ μmol/mm³ are enclosed in the light emission section, the projections 2b are formed with lighting of the lamp, whereby an arc is formed between the projections 2b.

In the light source apparatus according to the present invention, the main reflection mirror 20, the sub-reflection mirror 30, and the wavelength selective optical element 40 are not specifically limited to the above embodiments, as long as they reflect/transmit the radiation light from the short arc type mercury lamp. However, it is desirable to use members, which are excellent in heat resistance and strength resistance nature from a viewpoint of being used in a projector apparatus. Specifically, borosilicate glass, silica glass, etc. is used as the base material of the main reflector 20, and metal material such as aluminium can be used for the sub-reflection mirror 30 in addition to materials used as the main reflector 20. The reason why heat resistance is required is that the main reflector 20 reaches a high temperature of approximately 400° C. at time of lamp lighting, and the reason why the strength resistance nature is required, is so that the reflection mirrors are not damaged even if the short arc type mercury lamp is damaged during lighting, and the fragments of the short arc type mercury lamp, etc. may be certainly prevented from scattering.

The wavelength selective optical element 40 is desirably separated from the front opening of the sub-reflection mirror 30. In such a structure, it is possible to blow a cooling wind towards the sealing portions 12b of the short arc type mercury lamp 10. Moreover, although it is also possible to attach glass etc. to the front opening of the main reflector 20, that function can be given to the lens 41 or 42 which forms the wavelength selective optical element 40, so that much more miniaturization is attained.

According to the light source apparatus of the present invention, which has the structure for reflecting ultraviolet light having wavelength of 380 nm-400 nm, as to the main reflector 20, the sub-reflection mirror 30, and the lens 41, it was confirmed that optical power was improved by 7% in the structure shown in FIG. 1, as compared with the conventional light source apparatus which transmits ultraviolet light. According to the light source apparatus of the present invention, which has the structure for reflecting ultraviolet light with wavelength of 300 nm-400 nm, as to the main reflector 20, the sub-reflection mirror 30, and the lens 41 of the wavelength selective optical element 40, it was confirmed that optical power was improved by 10% in the structure shown in FIG. 1, as compared with the conventional light source apparatus which transmits ultraviolet light.

### REFERENCE SIGNS LIST

10 Short arc type mercury lamp
2a Hemisphere portion
2b Projection
2c Axis portion
11 Light emission section
12a and 12b Sealing portions
13, 13a, and 13b Electrodes
14a and 14b External leads
15a and 15b Metallic foils for electric conduction
20 Main reflection mirror
21 Base material
22 Reflection portion
24 Neck portion
25 Heat-resistant adhesive agent
30 Sub-reflection mirror
31 Base material
32 Interference films
40 Wavelength selective optical element
41 and 42 Lenses
43 and 44 Interference films
51, 53, 55 light
52 and 54 Return light

1-11. (canceled)

12. A light source apparatus comprising:
a short-arc-type mercury lamp that comprises a light emission section and sealing portions provided at both ends of the light emission section, the light emission section comprises a pair of electrodes, wherein an arc direction and an optical axis of the short-arc-type mercury lamp coincide with each other;
a main reflection mirror that comprises a reflection face in the shape of an ellipsoid of revolution and is arranged so as to surround the short-arc-type mercury lamp such that a primary focal point of the main reflection mirror is located on the optical axis between the electrodes;
a sub-reflection mirror that is arranged so as to surround an opening of the main reflection mirror such that the sub-reflection mirror reflects a portion of the light that is directly emitted from the short-arc-type mercury lamp toward an opening side of the main reflection mirror, said light reflected by the sub-reflection mirror being reflected toward the main reflection mirror, wherein an opening is formed in the sub-reflection mirror through which light reflected by the main reflection mirror passes; and
a wavelength selective optical element that is arranged between a second focal point of the main reflection mirror and the sub-reflection mirror such that the light that is reflected by the main reflection mirror and passes through the opening of the sub-reflection mirror is incident upon an incidence-side face of the wavelength selective optical element,
wherein the wavelength selective optical element is configured to transmit visible light incident upon the incidence-side face thereof and to reflect ultraviolet light incident upon the incidence-side face thereof,
wherein the main reflection mirror transmits infrared light emitted from the short-arc-type mercury lamp and reflects ultraviolet light and visible light emitted from the short-arc-type mercury lamp, and
wherein the sub-reflection mirror reflects ultraviolet light and visible light emitted from the short-arc-type mercury lamp.

13. The light source apparatus according to claim 12, wherein the sub-reflection mirror transmits infrared light emitted from the short-arc-type mercury lamp.

14. The light source apparatus according to claim 12, wherein the sub-reflection mirror is made from aluminum material.

15. The light source apparatus according claim 12, wherein the incidence-side face of the wavelength selective optical element is formed such that light that is reflected by the main reflection mirror and passes through the opening of the sub-reflection mirror is vertically incident thereon, and a film is formed on the incidence-side face of the wavelength selective optical element that transmits visible light and reflects ultraviolet light.

16. The light source apparatus according to claim 12, wherein the incidence-side face of the wavelength selective optical element is flat and has a film formed thereon that transmits visible light and reflects ultraviolet light.

17. The light source apparatus according to claim 12, wherein the sub-reflection mirror is a spherical reflection mirror.

18. The light source apparatus according to claim 12, wherein a largest diameter of the main reflection mirror and a largest diameter of the sub-reflection mirror coincide with each other.

19. The light source apparatus according to claim 12, wherein a largest diameter of the sub-reflection mirror is larger than a largest diameter of the main reflection mirror.

20. The light source apparatus according to claim 12, wherein the sub-reflection mirror is continuously formed to the main reflection mirror at the opening of the main reflection mirror such that a relation of 30 degrees≦X≦90 degrees is satisfied wherein X is an angle between the optical axis of the main reflection mirror and a virtual line drawn from a point centrally between the electrodes to a boundary part where the sub-reflection mirror and the main reflection mirror meet.

21. The light source apparatus according to claim 12, wherein a projection is formed at the tip of each of the electrodes of the short-arc-type mercury lamp.

22. A projector comprising the light source apparatus according to claim 12.
